(19) United States
(12) Patent Application Publication
(10) Pub. No.: US 2021/0144618 A1
(43) Pub. Date: May 13, 2021

(54) METHOD FOR ACCESSING NETWORK BY USER EQUIPMENT IN WIRELESS COMMUNICATION SYSTEM AND DEVICE THEREFOR

(71) Applicant: LG ELECTRONICS INC., Seoul (KR)

(72) Inventor: Sungduck CHUN, Seoul (KR)

(73) Assignee: LG ELECTRONICS INC., Seoul (KR)

(21) Appl. No.: 16/961,920

(22) PCT Filed: Jan. 7, 2019
(86) PCT No.: PCT/KR2019/000227

§ 371 Date: Sep. 18, 2020

Related U.S. Application Data
(60) Provisional application No. 62/616,437, filed on Jan. 12, 2018.

(51) Int. Cl. H04W 48/02; H04W 48/16; H04W 48/08; H04W 60/04

(52) U.S. Cl. CPC H04W 48/02; H04W 60/04; H04W 48/08; H04W 48/16

(57) ABSTRACT

Disclosed are a method for accessing a network by user equipment in a wireless communication system and a device therefor. More specifically, a method for accessing a network by user equipment (UE) in a wireless communication system comprises the steps of: receiving access information regarding access identity and access category values that are valid in a cell in which the UE is camping; selecting, when an access attempt is made to the network, values associated with the access attempt from the access identity and access category values that are valid in the cell on the basis of the access information; and performing an access barring check on the basis of the selected access identity and access category values, thereby enabling access to the network.

### CROSS-REFERENCE TO RELATED APPLICATION

This application is the National Stage filing under 35 U.S.C. 371 of International Application No. PCT/KR2019/000227, filed on Jan. 7, 2019, which claims the benefit of U.S. Provisional Application No. 62/616,437, filed on Jan. 12, 2018, the contents of which are all hereby incorporated by reference herein in their entirety.

### TECHNICAL FIELD

The present disclosure relates to a wireless communication system, and more particularly to a method for a user equipment having a different access parameter from a network to access the network in a wireless communication system and a device supporting the same.

### BACKGROUND ART

Mobile communication systems have been developed to provide voice services while guaranteeing user mobility. Such mobile communication systems have gradually expanded their coverage from voice services up to data services. However, as current mobile communication systems suffer resource shortages due to the explosion of traffic and users demand even higher-speed services, development of more advanced mobile communication systems is needed.

The requirements of the next-generation mobile communication system may roughly include supporting huge data traffic, a remarkable increase in a transfer rate of each user, the accommodation of the significantly increased number of connection devices, very low end-to-end latency, and high energy efficiency. To this end, various techniques, such as dual connectivity, massive multiple input multiple output (MIMO), in-band full duplex, non-orthogonal multiple access (NOMA), supporting super-wide band, and device networking, have been studied.

### DISCLOSURE

### Technical Problem

The present disclosure provides a method for a user equipment (UE) to access a network in a wireless communication system.

The present disclosure also provides a communication system and a method such that a network efficiently controls an access from a UE in a situation in which there are the UE and the network each having a different parameter, and at the same time the UEs have uniform operation characteristics.

The technical problems to be solved by the present disclosure are not limited by the above-mentioned technical problems, and other technical problems which are not mentioned above can be clearly understood from the following description by those skilled in the art to which the present disclosure pertains.

### Technical Solution

In one aspect, there is provided a method for a user equipment (UE) to access a network in a wireless communication system, the method comprising receiving access information about valid access identity and access category values in a cell on which the UE camps; based on performing an access attempt to the network, selecting a value related to the access attempt among the valid access identity and access category values in the cell based on the access information; and performing a access barring check based on the selected access identity and access category value.

In another aspect, there is provided a user equipment (UE) accessing a network in a wireless communication system, the UE comprising a transceiver configured to transmit and receive a radio signal, and a processor configured to control the transceiver, wherein the transceiver is configured to receive access information about valid access identity and access category values in a cell on which the UE camps, wherein the processor is configured to, based on performing an access attempt to the network, select a value related to the access attempt among the valid access identity and access category values in the cell based on the access information, and perform a access barring check based on the selected access identity and access category value.

The access information may be included in a system information block (SIB).

The SIB may be received by a radio resource control (RRC) layer of the UE.

The access information may be received in a registration procedure of the UE.

The registration procedure may be performed by a non-access stratum (NAS) layer of the UE.

The method may further comprise transferring, by the RRC layer, the access information to a non-access stratum (NAS) layer of the UE.

The selecting of the value related to the access attempt may be performed by the NAS layer.

The method may further comprise transferring, by the NAS layer, the selected value related to the access attempt to the RRC layer.

The access barring check may be performed by the RRC layer.

The method may further comprise updating, by the NAS layer, the valid access identity and access category values in the cell, on which the UE camps, based on the access information.

The access information may further include invalid access identity and access category values in the cell.

### Advantageous Effects

Embodiments of the present disclosure can allow a user equipment (UE) to efficiently access a network in a wireless communication system.

Furthermore, embodiments of the present disclosure can allow a network to efficiently control an access from a UE in a situation in which there are the UE and the network each having a different parameter, and at the same time, allow the UEs to perform communication with uniform operation characteristics.

Effects obtainable from the present disclosure are not limited by the effects mentioned above, and other effects which are not mentioned above can be clearly understood from the following description by those skilled in the art to which the present disclosure pertains.

### DESCRIPTION OF DRAWINGS

The accompanying drawings, which are included to provide a further understanding of the present disclosure and constitute a part of the detailed description, illustrate embodiments of the present disclosure and together with the description serve to explain the principle of the present disclosure.

FIG. 1 schematically illustrates an evolved packet system (EPS) to which the present disclosure is applicable.

FIG. 2 illustrates an example of a network structure of an evolved universal terrestrial radio access network (E-UTRAN) to which the present disclosure is applicable.

FIG. 3 illustrates a method for a user equipment to access a network in a wireless communication system according to an embodiment of the present disclosure.

FIG. 4 illustrates a method for a user equipment to access a network in a wireless communication system according to an embodiment of the present disclosure.

FIG. 5 illustrates a block configuration diagram of a communication device according to an embodiment of the present disclosure.

FIG. 6 illustrates a block configuration diagram of a communication device according to an embodiment of the present disclosure.

### MODE FOR INVENTION

Reference will now be made in detail to embodiments of the disclosure, examples of which are illustrated in the accompanying drawings. A detailed description to be disclosed below together with the accompanying drawing is to describe exemplary embodiments of the present disclosure and not to describe a unique embodiment for carrying out the present disclosure. The detailed description below includes details to provide a complete understanding of the present disclosure. However, those skilled in the art know that the present disclosure can be carried out without the details.

In some cases, in order to prevent a concept of the present disclosure from being ambiguous, known structures and devices may be omitted or illustrated in a block diagram format based on core functions of each structure and device.

In the present disclosure, a base station (BS) means a terminal node of a network directly performing communication with a terminal. In the present disclosure, specific operations described to be performed by the base station may be performed by an upper node of the base station, if necessary or desired. That is, it is obvious that in the network consisting of multiple network nodes including the base station, various operations performed for communication with the terminal can be performed by the base station or network nodes other than the base station. The ‘base station (BS)’ may be replaced with terms, such as a fixed station, Node B, evolved-NodeB (eNB), a base transceiver system (BTS), and an access point (AP). Further, a ‘terminal’ may be fixed or movable and may be replaced with terms such as user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, a device-to-device (D2D) communication device, and the like.

In the present disclosure, downlink (DL) means communication from the base station to the terminal, and uplink (UL) means communication from the terminal to the base station. In the downlink, a transmitter may be a part of the base station, and a receiver may be a part of the terminal. In the uplink, the transmitter may be a part of the terminal, and the receiver may be a part of the base station.

Specific terms used in the following description are provided to help the understanding of the present disclosure, and may be changed to other forms within the scope without departing from the technical spirit of the present disclosure.

Embodiments of the present disclosure can be supported by standard documents disclosed in at least one of IEEE 802, 3GPP and 3GPP2 which are the wireless access systems. That is, steps or parts in embodiments of the present disclosure which are not described to clearly show the technical spirit of the present disclosure can be supported by the standard documents. Further, all terms described in the present documents can be described by the standard document.

The 3GPP 5th generation (5G) system is primarily described for clear description, but technical features of the present disclosure are not limited thereto.

Terms used in the present disclosure may be defined as follows.
Evolved Packet System (EPS): a network system consisting of an evolved packet core (EPC), that is an Internet protocol (IP) based packet switched core network, and an access network such as LTE and UTRAN. The EPS is a network of an evolved version of a universal mobile telecommunications system (UMTS).
eNodeB: a base station of an EPS network. It is installed outdoor, and its coverage has a scale of a macro cell.
International Mobile Subscriber Identity (IMSI): an internationally unique subscriber identity allocated in a mobile communication network.
Public Land Mobile Network (PLMN): a network configured for the purpose of providing mobile communication services to individuals. The PLMN can be configured for each operator.
5G system (5GS): a system consisting of a 5G access network (AN), a 5G core network and a user equipment (UE).
5G Access Network (5G-AN) (or AN): an access network consisting of a new generation radio access network (NG-RAN) and/or a non-3GPP access network (AN) connected to the 5G core network.
New Generation Radio Access Network (NG-RAN) (or RAN): a radio access network having a common feature of being connected to 5GC and supporting one or more of the following options:

1) Standalone New Radio

2) New radio that is an anchor supporting E-UTRA extension

3) Standalone E-UTRA (e.g., eNodeB)

4) Anchor supporting new radio extension.
5G Core Network (5GC): a core network connected to a 5G access network.
Network Function (NF): means a processing function adopted in 3GPP within a network or defined in 3GPP. The processing function includes a defined functional behavior and an interface defined in 3GPP.
NF service: a function exposed by the NF via a service-based interface and consumed by other authenticated NF(s).
Network Slice: a logical network that provides specific network capability(s) and network feature(s).
Network Slice Instance: a set of NF instance(s) and required resources(s) (e.g., compute, storage, and networking resources) that form a deployed network slice.
Protocol Data Unit (PDU) Connectivity Service: service providing the exchange of PDU(s) between the UE and a data network.
PDU Connectivity Service: service providing the exchange of PDU(s) between the UE and a data network.
PDU Session: association between the UE and the data network that provide the PDU connectivity service. An association type may be Internet protocol (IP), Ethernet, or unstructured.
Non-Access Stratum (NAS): a functional layer for sending and receiving signaling and a traffic message between the UE and the core network in EPS and 5GS protocol stack. The NAS mainly functions to support mobility of the UE and support a session management procedure.

5G System Architecture to which the Present Disclosure is Applicable

A 5G system is an advanced technology from 4G LTE mobile communication technology and supports a new radio access technology (RAT), extended long term evolution (eLTE) as an extended technology of LTE, non-3GPP access (e.g., wireless local area network (WLAN) access), etc. through the evolution of an existing mobile communication network structure or a clean-state structure.

The 5G system architecture is defined to support data connectivity and services so that deployment thereof can use technologies, such as network function virtualization and software-defined networking. The 5G system architecture utilizes service-based interactions between control plane (CP) network functions (NFs).

FIG. 1 illustrates an architecture of a wireless communication system to which the present disclosure is applicable.

The 5G system architecture may include various components (i.e., network functions (NFs)), and FIG. 1 illustrates some of the various components.

An access and mobility management function (AMF) supports functions of inter-core network (CN) node signaling for mobility between 3GPP access networks, termination of radio access network (RAN) CP interface N2, termination N1 of NAS signaling, registration management (registration area management), idle mode UE reachability, support of network slicing, SMF selection, and the like.

Some or all of the functions of the AMF can be supported in a single instance of one AMF.

A data network (DN) means, for example, operator services, internet access, or 3rd party service, etc. The DN transmits a downlink protocol data unit (PDU) to the UPF or receives the PDU transmitted from the UE from the UPF.

A policy control function (PCF) receives information about packet flow from an application server and provides functions of determining policies such as mobility management and session management.

A session management function (SMF) provides a session management function. If the UE has a plurality of sessions, the sessions can be respectively managed by different SMFs.

Some or all of the functions of the SMF can be supported in a single instance of one SMF.

A unified data management (UDM) stores subscription data of user, policy data, etc.

A user plane function (UPF) transmits the downlink PDU received from the DN to the UE via the (R)AN and transmits the uplink PDU received from the UE to the DN via the (R)AN.

An application function (AF) interacts with 3GPP core network to provide services (e.g., to support functions of an application influence on traffic routing, network capability exposure access, interaction with policy framework for policy control, etc.).

A (radio) access network (R)AN collectively refers to a new radio access network supporting both evolved E-UTRA, that is an evolved version of 4G radio access technology, and a new radio (NR) access technology (e.g., gNB).

The gNB supports functions for radio resource management (i.e., radio bearer control, radio admission control, connection mobility control, and dynamic allocation of resources (i.e., scheduling) to the UE in uplink/downlink)

The UE refers to a user equipment.

In the 3GPP system, a conceptual link connecting between the NFs in the 5G system is defined as a reference point.

N1 (or NG1) is a reference point between the UE and the AMF, N2 (or NG2) is a reference point between the (R)AN and the AMF, N3 (or NG3) is a reference point between the (R)AN and the UPF, N4 (or NG4) is a reference point between the SMF and the UPF, N5 (or NG5) is a reference point between the PCF and the AF, N6 (or NG6) is a reference point between the UPF and the data network, N7 (or NG7) is a reference point between the SMF and the PCF, N24 (or NG24) is a reference point between the PCF in the visited network and the PCF in the home network, N8 (or NG8) is a reference point between the UDM and the AMF, N9 (or NG9) is a reference point between two core UPFs, N10 (or NG10) is a reference point between the UDM and the SMF, N11 (or NG11) is a reference point between the AMF and the SMF, N12 (or NG12) is a reference point between the AMF and an authentication server function (AUSF), N13 (or NG13) is a reference point between the UDM and the AUSF, N14 (or NG14) is a reference point between two AMFs, and N15 (or NG15) is a reference point between the PCF and the AMF in case of non-roaming scenario and a reference point between the PCF in the visited network and the AMF in case of roaming scenario.

FIG. 1 illustrates a reference model where the UE accesses one DN using one PDU session, for convenience of explanation. However, the present disclosure is not limited thereto.

FIG. 2 illustrates a radio protocol stack in a wireless communication system to which the present disclosure is applicable.

More specifically, FIG. 2(a) illustrates a radio interface user plane protocol stack between a UE and gNB, and FIG. 2(b) illustrates a radio interface control plane protocol stack between the UE and the gNB.

The control plane means a path through which control messages used for a UE and a network to manage calls are sent. The user plane means a path through which data generated in an application layer, for example, voice data or Internet packet data, etc. are transmitted.

Referring to FIG. 2(a), the user plane protocol stack may be divided into Layer 1 (i.e., physical (PHY) layer) and Layer 2.

Referring to FIG. 2(b), the control plane protocol stack may be divided into Layer 1 (i.e., PHY layer), Layer 2, Layer 3 (i.e., radio resource control (RRC) layer), and a non-access stratum (NAS) layer.

The Layer 2 is divided into a medium access control (MAC) sublayer, a radio link control (RLC) sublayer, a packet data convergence protocol (PDCP) sublayer, and a service data adaptation protocol (SDAP) sublayer (in case of the user plane).

A radio bearer is classified into two groups: data radio bearer (DRB) for user plane data and signaling radio bearer (SRB) for control plane data.

Each layer of the control plane and the user plane of the radio protocol is described below.

1) The Layer 1, i.e., the PHY layer, provides information transfer service to an upper layer by using a physical channel. The PHY layer is connected to the MAC sublayer located at an upper level through a transport channel, and data is transmitted between the MAC sublayer and the PHY layer through the transport channel. The transport channel is classified according to how and which feature data is transmitted via a radio interface. And, data is transmitted between different PHY layers, between a PHY layer of a transmitter and a PHY layer of a receiver, through a physical channel.

2) The MAC sublayer performs mapping between a logical channel and a transport channel; multiplexing/demultiplexing of MAC service data unit (SDU) belonging to one or different logical channel(s) to/from a transport block (TB) delivered to/from the PHY layer through a transport channel; scheduling information reporting; error correction through hybrid automatic repeat request (HARQ); priority handling between UEs using dynamic scheduling; priority handling between logical channels of one UE using logical channel priority; and padding.

Different kinds of data deliver a service provided by the MAC sublayer. Each logical channel type defines what type of information is delivered.

The logical channel is classified into two groups: a control channel and a traffic channel.

i) The control channel is used to deliver only control plane information and is as follows.
Broadcast Control Channel (BCCH): a downlink channel for broadcasting system control information.
Paging Control Channel (PCCH): a downlink channel that delivers paging information and system information change notification.
Common Control Channel (CCCH): a channel for transmitting control information between a UE and a network. This channel is used for UEs having no RRC connection with the network.
Dedicated Control Channel (DCCH): a point-to-point bi-directional channel for transmitting dedicated control information between the UE and the network. This channel is used by the UE with an RRC connection.

ii) The traffic channel is used to use only user plane information.
Dedicated Traffic Channel (DTCH): a point-to-point channel, dedicated to a single UE, for delivering user information. The DTCH may exist in both uplink and downlink.

In the downlink, connection between the logical channel and the transport channel is as follows.

The BCCH may be mapped to BCH. The BCCH may be mapped to DL-SCH. The PCCH may be mapped to PCH. The CCCH may be mapped to the DL-SCH. The DCCH may be mapped to the DL-SCH. The DTCH may be mapped to the DL-SCH.

In the uplink, connection between the logical channel and the transport channel is as follows. The CCCH may be mapped to UL-SCH. The DCCH may be mapped to the UL-SCH. The DTCH may be mapped to the UL-SCH.

3) The RLC sublayer supports three transmission modes: a transparent mode (TM), an unacknowledged mode (UM), and an acknowledged mode (AM).

The RLC configuration may be applied for each logical channel. For SRB, the TM or the AM is used. On the other hand, for DRB, the UM or the AM is used.

The RLC sublayer performs the delivery of the upper layer PDU; sequence numbering independent of PDCP; error correction through automatic repeat request (ARQ); segmentation and re-segmentation; reassembly of SDU; RLC SDU discard; and RLC re-establishment.

4) A PDCP sublayer for the user plane performs sequence numbering; header compression and decompression (robust header compression (RoHC) only); delivery of user data; reordering and duplicate detection (if the delivery to a layer above the PDCP is required); PDCP PDU routing (in case of a split bearer); re-transmission of PDCP SDU; ciphering and deciphering; PDCP SDU discard; PDCP re-establishment and data recovery for RLC AM; and duplication of PDCP PDU.

The PDCP sublayer for the control plane additionally performs sequence numbering; ciphering, deciphering and integrity protection; delivery of control plane data; duplicate detection; and duplication of PDCP PDU.

When duplication is configured for a radio bearer by RRC, an additional RLC entity and an additional logical channel are added to the radio bearer to control the duplicated PDCP PDU(s). The duplication at PDCP includes transmitting the same PDCP PDUs twice. Once it is transmitted to the original RLC entity, and a second time it is transmitted to the additional RLC entity. In this instance, the original PDCP PDU and the corresponding duplicate are not transmitted to the same transport block. Two different logical channels may belong to the same MAC entity (in case of CA) or different MAC entities (in case of DC). In the former case, logical channel mapping restriction is used to ensure that the original PDCP PDU and the corresponding duplicate are not transmitted to the same transport block.

5) The SDAP sublayer performs i) mapping between QoS flow and data radio bearer, and ii) QoS flow identification (ID) marking in downlink and uplink packet.

A single protocol entity of SDAP is configured for each individual PDU session, but exceptionally, two SDAP entities may be configured for dual connectivity (DC).

6) A RRC sublayer performs broadcast of system information related to access stratum (AS) and non-access stratum (NAS); paging initiated by 5GC or NG-RAN; establishment, maintenance and release of RRC connection between UE and NG-RAN (additionally including modification and release of carrier aggregation and also additionally including modification and release of dual connectivity between E-UTRAN and new radio (NR) or in NR); security function including key management; establishment, configuration, maintenance and release of SRB(s) and DRB(s); delivery of handover and context; UE cell selection and re-release and control of cell selection/reselection: mobility function including inter-RAT mobility; QoS management function, UE measurement reporting and control of reporting; detection of radio link failure and recovery from radio link failure; and NAS message delivery from NAS to UE and NAS message delivery from UE to NAS.

User Data Protection Method

Terms used in the present disclosure may be defined as follows.
Subscription Identifier De-concealing Function (SIDF): a function located within home network responsible for a function of de-concealing a subscription permanent identifier (SUPI) from a subscription concealed identifier (SUCI).
Subscription Concealed Identifier (SUCI): one-time use subscription identifier that contains a concealed subscription identifier (e.g., mobile subscription identification number (MSIN)) and a cleartext home network Identifier (e.g., mobile country code (MCC) and mobile network code (MNC). The SUCI is used to privacy-protect the SUPI.
UE 5G Security Capability: the UE security capabilities for 5G access stratum (AS) and non-access stratum (NAS)

A plurality of user equipments (UEs) may access a communication system, and several services may be present for the UEs. If there are data communication requests from the plurality of UEs and services, but the network cannot accept the data communication requests of all the UEs and services, the network needs to increase the stability of a system by controlling the access requests from the UEs. If not, a problem that a communication access request such as an emergency call is not properly processed may occur.

Such an access control method is commonly called an access control, and the following method is specified in TS 22.261 V15.3.0.

Unified Access Control

Depending on operator policies, deployment scenarios, subscriber profiles, and available services, different criteria are used in determining which access attempt should be allowed or blocked when communication congestion occurs in the 5G System. These different criteria for access control are associated with access identities and access categories. The 5G system provides a single unified access control where operators control the accesses based on these two aspects.

In the unified access control, each access attempt is categorized into one or more access identities and one access categories. Based on access control information applicable for the access identity and access category associated/matched with the access attempt, the UE tests whether or not the actual access attempt can be made.

The unified access control supports extensibility to allow the inclusion of additional standardized access identities and access categories and supports flexibility to allow operators to define operator-defined access identities and access categories using their own criterion.

Additionally, the use of legacy Access Classes 11-15 is expanded upon to potentially allow an access attempt to succeed that otherwise may have been barred based on the type of user.

Based on the operator's policy, the 5G system shall be able to prevent the UEs from accessing the network using relevant barring parameters that depend on the access identity and the access category. The access identities are configured at the UE as listed in the following Table 1. The access categories are defined by the combination of conditions related to the UE and types of access attempt as listed in the following Table 2. One or more access identities and only one access category are selected and tested for an access attempt.

The 5G network may transmit barring control information in one or more areas of the RAN.

The UE shall be able to determine whether or not a particular new access attempt is allowed based on barring parameters that the UE receives from the barring control information and the configuration of the UE.

In the case of several core networks sharing the same RAN, the RAN shall be able to apply the access control for the different core networks.

A unified access control framework is applicable both to UEs accessing a 5G core network (CN) using E-UTRA and to UEs accessing the 5G CN using new radio (NR).

The unified access control framework shall be applicable to UEs in RRC idle, RRC inactive, and RRC connected states at the time of initiating a new access attempt.

The 5G system supports operator-defined access categories that an operator may mutually exclusively define.

The unified access control framework is applicable to inbound roamers to a PLMN. The PLMN should be able to provide the definition of operator-defined access categories to the UE.

TABLE 1

| Access Identity | |
|---|---|
| Number | UE Configuration |
| 0 | UE is not configured with any parameter from this table. |
| 1 (NOTE 1) | UE is configured for multimedia priority service (MPS). |
| 2 (NOTE 2) | UE is configured for mission critical service (MCS). |
| 3-10 | Reserved for future use |
| 11 (NOTE 3) | Access Class 11 is configured in the UE. |
| 12 (NOTE 3) | Access Class 12 is configured in the UE. |
| 13 (NOTE 3) | Access Class 13 is configured in the UE. |
| 14 (NOTE 3) | Access Class 14 is configured in the UE. |
| 15 (NOTE 3) | Access Class 15 is configured in the UE. |

(NOTE 1):
Access Identity 1 is used to provide overrides according to the subscription information in UEs configured for MPS. The subscription information defines whether an override applies to the corresponding UE within one of the following categories:
a) UEs that are configured for the MPS;
b) UEs that are configured for MPS and are in the PLMN listed as most preferred PLMN of the country where the UE is roaming in the operator-defined PLMN selector list or in their HPLMN or in a PLMN that is equivalent to their HPLMN;
c) UEs that are configured for MPS and are in their HPLMN or in a PLMN that is equivalent to it.
(NOTE 2):
Access Identity 2 is used to provide overrides according to the subscription information in UEs configured for MPS. The subscription information defines whether an override applies to UEs within one of the following categories:
a) UEs that are configured for MCS;
b) UEs that are configured for MCS and are in the PLMN listed as most preferred PLMN of the country where the UE is roaming in the operator-defined PLMN selector list or in their HPLMN or in a PLMN that is equivalent to their HPLMN;
c) UEs that are configured for MCS and are in their HPLMN or in a PLMN that is equivalent to it.
(NOTE 3):
Access identities 11 and 15 are valid in home PLMN (HPLMN) only if an equivalent HPLMN (EHPLMN) list is not present or in any EHPLMN. Access identities 12, 13 and 14 are valid in home PLMN and visited PLMNs of home country only. For this purpose, the home country is defined as the country of the MCC part of the IMSI.

The access identities may be barred at any one time.

TABLE 2

| Access Category | Conditions | Type of |
|---|---|---|
| Number | related to UE | access attempt |
| 0 | All | Mobile Originating (MO) |
| | | signaling resulting from paging |
| 1 (NOTE 1) | UE is configured for delay | All except for Emergency |
| | tolerant service and subject to | |
| | access control for access category 1, | |
| | which is judged based on UE′HPLMN | |
| | and the selected PLMN. | |
| 2 | All | Emergency access attempt |
| 3 | All except for the conditions in | MO signalling resulting |
| | access category 1 | from other than paging |
| 4 | All except for the conditions in | MMTEL voice |
| | access category 1 | |
| 5 | All except for the conditions in | MMTEL video |
| | access category 1 | |
| 6 | All except for the conditions in | SMS |
| | access category 1 | |
| 7 | All except for the conditions in | MO data that do not belong |
| | access category 1 | to any other access categories |
| 8-31 | | Reserved standardized |
| | | access categories |
| 32-63 (NOTE 2) | All | Type of access attempt based |
| | | on user classification |

(NOTE 1):
The barring parameter for access category 1 is accompanied with information that define whether the access category applies to UEs within one of the following categories:
a) UEs that are configured for delay tolerant service;
b) UEs that are configured for delay tolerant service and are in their HPLMN or in a PLMN that is equivalent to it;
c) UEs that are configured for delay tolerant service and are neither in the PLMN listed as most preferred PLMN of the country where the UE is roaming in the operator-defined PLMN selector list on the SIM/USIM, nor in their HPLMN nor in a PLMN that is equivalent to their HPLMN.
(NOTE 2):
When there are an access category based on operator classification and a standardized access category to both of which an access attempt can be categorized, and the standardized access category is neither 0 nor 2, the UE applies the access category based on operator classification. When there are an access category based on operator classification and a standardized access category to both of which an access attempt can be categorized, and the standardized access category is 0 or 2, the UE applies the standardized access category.

The current access control method is a method of applying access control parameters based on the access identity and access category values. Standardized values are present in the access identity and the access category, and this is to ensure a certain UE operation between different operators.

For example, when there is a UE subscribed in PLMN A, the UE cannot use services of PLMN A according to a situation (e.g., when the UE moves abroad). Therefore, the UE accesses an operator, for example, PLMN B available in an area to which the UE has moved, and should receive services from the PLMN B. However, if access identity and access category defined in the PLMN A are different from access identity and access category defined in the PLMN B, the UE may not be able to normally access the PLMN B.

In order to prevent this, access types, that can be commonly applied to all the PLMNs and should be commonly supported by all the operators, have been stipulated, and the access types are standardized values and are reflected in access identity and access category.

In the current release-15, Nos. 0 to 31 have been allocated as standardized values in the access category. The practical uses of Nos. 0 to 7 have been defined, and the uses of Nos. 8 to 31 have not been yet defined and have been left to be used in the specifications to be announced later.

As described above, the standardized values ensure that the UE is stably subject to the application of the access control and accesses the system to receive the services, by applying the access control even if the UE moves between different PLMNs or different operators. However, the above method is still not complete.

For example, 3GPP specification of different releases may be used between different PLMNs or different operators. For example, any operator may use a network applying release-15 specification, and other operator may install a network applying release-16 or subsequent specification. In addition, even in the network of the same operator, the above operator may install the release-15 based network in some areas and install the network applying release-16 or subsequent specification in other areas considering regional characteristics or business environment.

There may occur a problem when new standardized values in the release-16 subsequent specification are allocated to the access category or the access identity in a situation where networks supporting the specifications of different versions are installed.

For example, the following cases may occur.
Situation 1: when a release-15 UE accesses a release-16 network, and the release-16 network transmits newly standardized access identity and access category values, the UE cannot know whether the above value is an error resulting from a decoding error of a message or a problem generated as the UE enters a new network. Further, because the UE cannot know what the above value is for, the UE cannot know whether or not the UE is able to attempt to access the network.
Situation 2: when a release-16 UE accesses a release-15 network, the UE selects access identity and access category value, that the UE will use, by criterion subsequent to release-16. When the selected access identity and access category value is a value that the release-15 network does not use, the network cannot control a radio access request from the UE if the UE uses the above value. Hence, a radio congestion phenomenon cannot be prevented.

In the following situation, an additional standardized value may be defined in the release-16 or subsequent specification.
This is a case, in which with the mass supply of virtual reality (VR) devices, all communication operators decide to use VR call as a new call type for voice call and video call. That is, even if the operators are different, it is possible to make a VR call to the other party using the phone number that we currently use. In this case, in order to control the access resulting from the outgoing of the VR call, the VR call may be designated as a new standardized access category in the release-16 subsequent specification.
This is a case, in which with the mass supply of vehicle communication, communication functions are installed in all vehicles. In this case, all the operators may recognize the vehicle as one UE type and add the UE configured for vehicle as a standardized access identity to the release-16 subsequent specification.

In order to solve the above problem, each network may consider a method of transmitting a specification version supported by the network through system information. However, if each network broadcasts a specification version supported by the network, this is like releasing performance information of the network to competitive operators. That is, if a network version is released to other operators, this may be used for disadvantageous purposes in marketing. Thus, methods other than the above method are needed.

FIG. 3 illustrates a method for a UE to access a network in a wireless communication system according to an embodiment of the present disclosure.

Referring to FIG. 3, the present disclosure describes a method, in which each network transmits access information about valid access identity and access category value or barred access identity and/or access category value in each cell, as a method for solving the problem described above.

If a UE camps on any cell or network, the UE receives the access information from the camped cell in S301.

The network may announce the access information through a system information block (SIB) received by a radio resource control (RRC) layer of the UE.

For example, there is a method described in the following Table 3.

TABLE 3
SystemInformationBlockType2 information element

| | |
|---|---|
| SystemInformationBlockType2 ::= | SEQUENCE { |

| | |
|---|---|
| Allowed-access-category-list | Allowed-access-category-list |
| Allowed-access-identities-list | Allowed-access-identies-list |

}

SystemInformationBlockType2 field descriptions

Allowed-access-category-list
List including values of allowed access categories in the cell
Allowed-access-identity-list
List including values of allowed access identities in the cell

If the RRC layer receives the access information from the network, the RRC layer transfers the access information to a non-access stratum (NAS) layer of the UE.

If the UE attempts access to the network, the UE selects a value associated/matched with the access attempt among the access identity and access category values, that are announced to be valid in the cell, based on the access information in S302.

When the UE attempts access to the network, the NAS layer selects an access identity and access category value associated/matched with the access attempt among the valid access identity and access category values in the camped cell in the access identity and access category values managed by the NAS layer, based on the access information transmitted by the RRC layer.

The UE performs an access barring check based on the selected access identity and access category value in S303.

Preferably, the NAS layer transmits the selected access identity and access category value to the RRC layer and instructs the access barring check.

Subsequently, the RRC layer tests whether or not the RRC layer performs the access to the network for the access identity and access category value received from the NAS layer using an access control parameter received from a base station. Then, if the access is allowed, the RRC layer performs the access.

Optionally, the UE may receive an access identity and access category value supported by any network in a process in which the UE performs registration with the network. In this case, since each cell does not need to transmit the valid access identity and access category value in the cell to the UE, there is an effect of capable of saving radio resources.

The method, in which the network transmits the valid access identity and access category value to the UE, has additionally the following effect through the registration procedure to the network or the UE configuration update process.
The network can manage access identity and access category value that is allowed or supported on a per tracking area (TA) basis. For example, any operator may install release-15 base station in some areas and install release-16 base station in some areas. If tracking areas of the release-15 base stations and tracking areas of the release-16 base stations are separated, the UE performs a tracking area update (TAU) process each time the UE moves between the release-15 base station and the release-16 base station. In this process, the network can update the access identity and access category value that is supported or allowed on a per TA basis.

Based on the updated values, the NAS layer can select a value suitable for its access purpose among the valid access category values in the corresponding area upon the access attempt of the UE.

FIG. 4 illustrates a method for a UE to access a network in a wireless communication system according to an embodiment of the present disclosure. An embodiment is described below with reference to FIG. 4,

1. A UE requests registration with a core network through a process 1A, and the core network accepts the UE's registration through a process 1B. Preferably, in this process, the network transfers, to the UE, information about valid access identity/access category value or barred access identity/access category value in a current TA/cell/PLMN.

2. The UE transfers information about the valid access identity/access category value and/or the barred access identity/access category value in the current TA/cell/PLMN to a radio network from an operation and maintenance (O&M) server or the core network optionally to the process 1.

3. If the UE receives the above information in the process 2, the radio network transfers, to the UE, information about the valid access identity/access category value and/or the barred access identity/access category value in the current TA/cell/PLMN through the SIB.

4. The RRC layer, that receives information about the valid access identity/access category value and/or the barred access identity/access category value in the current TA/cell/PLMN in the corresponding cell through the process 3, transfers the above information to the NAS layer of the UE.

5. The NAS layer receives information about the valid access identity/access category value and/or the barred access identity/access category value in the current TA/cell/PLMN and updates information about access identity/access category value available in the corresponding area in this process.

6. The NAS layer triggers access to the network.

7. The UE selects access identity/access category value associated/matched with the access to the network among the valid access identity/access category values in the above area based on information updated in the process 5.

8. The UE tests whether or not the UE attempts access in the corresponding area using the access identity/access category value selected in the process 7.

9. When the access has been allowed as a result of the process 8, the UE attempts access to the corresponding cell.

The above process has used a method of informing information about valid access identity and access category value in any area or any network. On the other hand, a method of informing information about access identity and access category value, which is not allowed in any area or is not supported by any network, may be similarly applied.

Each network or each cell may inform the UE of mapping information on each access identity and access category. The mapping information may indicate whether or not any access identity and access category value needs to be changed and applied.

For example, in the release-16, access category 8 may be newly defined as a VR call. In this case, when a VR call starts in the release-16 UE, the NAS layer of the UE may decide that the access category 8 is matched to the VR call, and transfer information about this to the lower RRC layer.

The network may transmit mapping information indicated in the following Table 4 through the SIB, etc.

TABLE 4

| Mapping | Source | Target |
|---|---|---|
| Rule Number | Access Category | Access Category |
| #1 | 8 | 5 |

That is, the network indicates to apply an access category of a VR video call to the VR call.

The network actually transmitting the above information does not need to know what the access category 8 means. The network only needs to transmit the above information as indicated by the operator. Thus, even if the access category 8 is newly defined in the release-16 and the above value is not used in the release-15, the release-16 UE can know how to apply access identity and/or access category value newly defined in the release-16 to the release-15 network when the release-15 network transmits the mapping information. In the same manner, the release-15 network can control access to a UE applying a newer specification than the release-15 network by transmitting the above information.

Therefore, when the RRC layer of the UE receives access category and access identity value for any access from the NAS layer of the UE, there is mapping information in the corresponding cell, and the access category and/or access identity informed by the NAS layer is present in the mapping information, the RRC layer tests whether or not the access requested by the NAS layer is allowed using a value indicated by the mapping information.

That is, in the above example, the NAS layer informs the RRC layer that the value of the access category is 8, and the RRC layer decides that not the access category 8 but the access category 5 should be applied for the access using the mapping information. The RRC layer tests whether or not the access is allowed in the above cell using an access control parameter corresponding to the access category 5 transmitted in an actual cell.

In the method of the above Table 2, IoT UEs are designated in a state of ‘configuration for delay tolerant service’ from the network, and thus is allocated to access category 1.

However, the control of the IoT UEs through the above method causes the following problem.
Example 1) Even if it is the IoT UE, high-priority information may be generated. A simple example may be a fire detector. The fire detector may be wirelessly connected to a control system of the fire department. In this case, normally, the fire detector may access the control system of the fire department at regular intervals to inform that the fire detector is operating properly. This periodic report does not cause a major problem even if a delay of several minutes or hours occurs. Therefore, when congestion has occurred in the network, this information may be processed with the lowest priority. However, if an actual fire occurs, the fire detector should inform the control system of the fire department of this fire as soon as possible. In this case, radio resources should be allocated to the fire detectors as first as possible. Nevertheless, in the current access control method, if the UE is configured with ‘configuration for delay tolerant service’ once, there is a problem that regardless of what data is generated in the actual UE, the data is processed with a low priority.
Example 2) As almost all the UEs are currently in the form of a smartphone, and tasks capable of being handled by the smartphone become increasingly, high-end smartphones continue to spread. In addition, the smartphones are increasingly used for financial business processing and personal authentication. Hence, when a smartphone is lost, damage and inefficiency of its owners are increasing. In order to prevent this, a method of continuously using location services for the purpose of preventing a loss is also increasing. However, the smartphones often use modems optimized for broadband communication services, and thus much power is consumed to maintain communication. In order to solve this, modem/function optimized for IoT communication is also applied to smartphones. Thus, in some cases, an IoT function is used even for a general purpose UE, and the UE should operate with configuration according to this. However, in the current access control method, if the ‘configuration for delay tolerant service’ is activated due to an IoT function installed in a certain smartphone, a problem occurs that other general services also have a lower priority at the same time.

Accordingly, in order to solve the problem, a method is necessary, which efficiently supports access of a complex UE with both IoT and broadband communication functions and also efficiently manage access priority according to data characteristics even in an IoT-only UE.

As a method for solving the problem described above, the network configures, to each UE, information about whether be able to use configuration for IoT and additionally configures information about when each UE can use the configuration for IoT.

As a first method to do this, ‘UE is configured for delay tolerant service’ or an item having meaning similar to this is allocated to an access identity. Based on this, the network can separately control access control parameters for the IoT UE and access control parameters for other UEs (e.g., general smartphone UEs).

This may be defined as in the following Table 5.

TABLE 5

| Access Identity | |
|---|---|
| Number | UE Configuration |
| 0 | UE is not configured with any parameter from this table. |
| 1 (NOTE 1) | UE is configured for multimedia priority service (MPS). |
| 2 (NOTE 2) | UE is configured for mission critical service (MCS). |
| 3 | UE is configured for delay tolerant service. |
| 4-10 | Reserved for future use |
| 11 (NOTE 3) | Access Class 11 is configured in the UE. |
| 12 (NOTE 3) | Access Class 12 is configured in the UE. |
| 13 (NOTE 3) | Access Class 13 is configured in the UE. |
| 14 (NOTE 3) | Access Class 14 is configured in the UE. |
| 15 (NOTE 3) | Access Class 15 is configured in the UE. |

According to this, the UE for IoT services may use access identity 3, and the smartphone may use access identity 0.

Further, the network may additionally provide the UE with information about when the UE can use each access identity, or when each access identity is valid.

For example, the network may provide the UE with the following information, for example, access identity validity information.
The access identity 3 is valid in the following examples:

Example 1) data is generated by application X.

In this case, when a plurality of applications is installed in any UE, if data is generated in application X, it is processed for IoT, i.e., processed as the access identity 3. If data is generated in other applications, it is processed as value other than the access identity 3, for example, access identity 0.

Example 2) data is generated by application X except that Y field is configured with Z.

In this case, usual data in the application X is processed for IoT, and for a specific field of header among data generated in the application X, for example, when the Y field is configured with Z, it is processed as general data not IoT data.

Example 3) specific time zone or specific area

As above, if the UE receives access identity validity information from the network, the UE stores it in a memory. If access to the actual network occurs, the UE determines an access identify to be used based on the above information.

Based on the determined access identity, the UE checks whether to perform the selected access barring.

A second method is to define an access category for delay tolerant service in the access categories and to transmit information when the access category is validly used.

When it is difficult to use an additional code point for separating the general case from the IoT case because a space is limited, an access identity may use the second method instead of the first method.

In this case, access category 1 is defined as in the following Table 6.

TABLE 6

| Access Category | Conditions | Type of |
|---|---|---|
| Number | related to UE | access attempt |
| 0 | All | Mobile Originating (MO) |
| | | signaling resulting from paging |
| 1 (NOTE 1) | All | MO data matched with conditions |
| | | given by access category 1 |
| | | validity information |
| 2 | All | Emergency access attempt |
| 3 | All | MO signalling resulting |
| | | from other than paging |
| 4 | All | MMTEL voice |
| 5 | All | MMTEL video |
| 6 | All | SMS |
| 7 | All | MO data that do not belong |
| | | to any other access categories |
| 8-31 | | Reserved standardized |
| | | access categories |
| 32-63 (NOTE 2) | All | Type of access attempt based |
| | | on user classification |

The network additionally provides the UE with access category 1 validity information considering that data of different characteristics may occur in the UE. Based on this, when any access occurs and the access additionally meets conditions indicated in the access category 1 validity information, the UE applies the access category 1.

For example, the access category 1 validity information may include the following information.
Application name, ID
Value of a specific field of IP header
PDN session information
DNN information
Service data characteristics
Bearer information
pppp information
QoS/5QI information

Alternatively, the network provides the UE with a routing rule for each traffic through universal software radio peripheral (USRP). In this process, the network may transfer, to each routing rule, information about whether or not traffic corresponding to the routing rule is matched to the access category 1. In this case, when any data is generated, the UE receiving the above information searches a routing rule corresponding to the data and tests whether or not the data is subject to the application of the access category 1. This is another way of implementing the access category 1 validity information.

When the UE has the access category 1 validity information in a process of selecting an access category associated/matched with an access, the UE tests whether the access is associated/matched with access category 0 or 2. If not, the UE tests whether or not the access is associated/matched with the access category 1. If the access is not matched, the UE tests whether or not the access is matched with other access categories.

In the above description, as a method of configuring, to each UE, information about whether be able to use configuration for IoT, there is a method in which when the UE performs a registration procedure, the network informs the UE of whether to use configuration for IoT as a response to this.

Preferably, the UE and the network may exchange the above information through a NAS message, or may receive the above information through an open mobile alliance device management (OMA DM) process.

In the above description, whether be able to use configuration for IoT may be defined as a name that extended access barring, etc. have been configured, or a name that NAS signal low priority etc. have been configured, or a name of configuration for delay tolerant, or a name similar to this.

Overview of Device to which the Present Disclosure is Applicable

FIG. 5 illustrates a block configuration diagram of a communication device according to an embodiment of the present disclosure.

Referring to FIG. 5, a wireless communication system includes a network node 510 and a plurality of UEs 520.

The network node 510 includes a processor 511, a memory 512, and a communication module 513. The processor 511 implements functions, processes, and/or methods proposed in FIGS. 1 to 4. Layers of wired/wireless interface protocol may be implemented by the processor 511.

The memory 512 is connected to the processor 511 and stores various types of information for driving the processor 511. The communication module 513 is connected to the processor 511 and transmits and/or receives wired/wireless signals. An example of the network node 510 may correspond to a base station, MME, HSS, SGW, PGW, SCEF, SCS/AS, or the like. In particular, if the network node 510 is the base station, the communication module 513 may include a radio frequency (RF) unit for transmitting/receiving a radio signal.

The UE 520 includes a processor 521, a memory 522, and a communication module (or RF unit) 523. The processor 521 implements functions, processes, and/or methods proposed in FIGS. 1 to 4. Layers of a radio interface protocol may be implemented by the processor 521. In particular, the processor may include a NAS layer and an AS layer. The memory 522 is connected to the processor 521 and stores various types of information for driving the processor 521. The communication module 523 is connected to the processor 521 and transmits and/or receives a radio signal.

The memories 512 and 522 may be inside or outside the processors 511 and 521 and may be connected to the processors 511 and 521 through various well-known means. Further, the network node 510 (in case of the base station) and/or the UE 520 may have a single antenna or multiple antennas.

FIG. 6 illustrates a block configuration diagram of a communication device according to an embodiment of the present disclosure.

In particular, FIG. 6 illustrates in more detail the UE illustrated in FIG. 5.

Referring to FIG. 6, the UE may include a processor (or digital signal processor (DSP)) 610, an RF module (or RF unit) 635, a power management module 605, an antenna 640, a battery 655, a display 615, a keypad 620, a memory 630, a subscriber identification module (SIM) card 625 (which is optional), a speaker 645, and a microphone 650. The UE may also include a single antenna or multiple antennas.

The processor 610 implements functions, processes, and/or methods proposed in FIGS. 1 to 4. Layers of a radio interface protocol may be implemented by the processor 610.

The memory 630 is connected to the processor 610 and stores information related to operations of the processor 610. The memory 630 may be inside or outside the processor 610 and may be connected to the processors 610 through various well-known means.

A user inputs instructional information, such as a telephone number, for example, by pushing (or touching) buttons of the keypad 620 or by voice activation using the microphone 650. The processor 610 receives and processes the instructional information to perform an appropriate function, such as to dial the telephone number. Operational data may be extracted from the SIM card 625 or the memory 630. Further, the processor 610 may display instructional information or operational information on the display 615 for the user's reference and convenience.

The RF module 635 is connected to the processor 610 and transmits and/or receives an RF signal. The processor 610 forwards instructional information to the RF module 635 in order to initiate communication, for example, transmit a radio signal configuring voice communication data. The RF module 635 includes a receiver and a transmitter to receive and transmit the radio signal. The antenna 640 functions to transmit and receive the radio signal. Upon reception of the radio signal, the RF module 635 may transfer a signal to be processed by the processor 610 and convert the signal into a baseband. The processed signal may be converted into audible or readable information output via the speaker 645.

The aforementioned embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. Software code may be stored in a memory unit and executed by a processor. The memory unit may be located at the interior or exterior of the processor and may transmit data to and receive data from the processor via various known means.

It will be apparent to those skilled in the art that various modifications and variations may be made in the present disclosure without departing from the spirit or scope of the present disclosure. Thus, it is intended that the present disclosure covers the modifications and variations of this disclosure provided they come within the scope of the appended claims and their equivalents.

### INDUSTRIAL APPLICABILITY

Although the present disclosure has been described focusing on examples applying to the 5G system, it can be applied to various wireless communication systems other than the 3GPP 5G system.

1. A method for a user equipment (UE) to access a network in a wireless communication system, the method comprising:
receiving access information about valid access identity and access category values in a cell on which the UE camps;
based on performing an access attempt to the network, selecting a value related to the access attempt among the valid access identity and access category values in the cell based on the access information; and
performing a access barring check based on the selected access identity and access category value.

2. The method of claim 1, wherein the access information is included in a system information block (SIB).

3. The method of claim 2, wherein the SIB is received by a radio resource control (RRC) layer of the UE.

4. The method of claim 1, wherein the access information is received in a registration procedure of the UE.

5. The method of claim 4, wherein the registration procedure is performed by a non-access stratum (NAS) layer of the UE.

6. The method of claim 3, further comprising transferring, by the RRC layer, the access information to a non-access stratum (NAS) layer of the UE.

7. The method of claim 6, wherein the selecting of the value related to the access attempt is performed by the NAS layer.

8. The method of claim 7, further comprising transferring, by the NAS layer, the selected value related to the access attempt to the RRC layer.

9. The method of claim 8, wherein the access barring check is performed by the RRC layer.

10. The method of claim 9, further comprising updating, by the NAS layer, the valid access identity and access category values in the cell, on which the UE camps, based on the access information.

11. The method of claim 3, wherein the access information further includes invalid access identity and access category values in the cell.

12. A user equipment (UE) accessing a network in a wireless communication system, the UE comprising:
a transceiver configured to transmit and receive a radio signal; and
a processor configured to control the transceiver,
wherein the transceiver is configured to receive access information about valid access identity and access category values in a cell on which the UE camps,
wherein the processor is configured to:
based on performing an access attempt to the network, select a value related to the access attempt among the valid access identity and access category values in the cell based on the access information; and
perform a access barring check based on the selected access identity and access category value.
